(19) United States
(12) Patent Application Publication
(10) Pub. No.: US 2022/0243067 A1
(43) Pub. Date: Aug. 4, 2022

(54) Method for forming a biodegradable or recyclable hybrid material composition

(71) Applicant: Brightplus Oy, Oulu (FI)

(72) Inventors: Jarkko Leivo, Oulu (FI); Admir Hadzic, Oulu (FI); Tuire Marin, Oulu (FI); Heli Kummala, Oulu (FI)

(21) Appl. No.: 17/625,811

(22) PCT Filed: Jul. 6, 2020
(86) PCT No.: PCT/FI2020/050482

§ 371 Date: Jan. 10, 2022

(30) Foreign Application Priority Data
Jul. 10, 2019 (EP) 19185388.6

(51) Int. Cl. C08L 101/16; C08L 67/04; C08J 3/075; C09D 167/04; C09D 183/04; B65D 65/46

(52) U.S. Cl. CPC C08L 101/16; C08L 67/04; B65D 65/46; C09D 167/04; C09D 183/04; C08J 3/075

(57) ABSTRACT

The present invention concerns a method for forming a biodegradable and recyclable hybrid material composition. In addition, the invention concerns a biodegradable hybrid material composition obtained by such method and use of such composition. The invention also relates to a coating composed of the composition according to the invention and use thereof. In particular, the present invention concerns a method comprising providing a polymetaloxane-biopolymer composition in liquid state and subjecting such composition to a curing step to form the hybrid material.

### BACKGROUND OF THE INVENTION

### Field of the Invention

The present invention concerns a method for forming a biodegradable or recyclable hybrid material composition. In addition, the invention concerns a biodegradable or recyclable hybrid material composition obtained by such method and use of such composition. The invention also relates to a coating composed of the composition according to the invention.

### Description of Related Art

Barrier properties are required in many applications such as packaging for foodstuffs, cosmetics, drugs and a like. Proper barrier properties protect the product inside the package from light, oxygen and moisture, preventing contamination. Furthermore, undesirable leaching of the product to the outside of the package is prevented with barrier properties.

Currently, multi-layer or composite film structures are used to achieve the required barrier properties. Materials, such as metals, e.g., aluminium or tinplate, glass, polymers, e.g., PP, PE, PET or PVDC, and polymers provided with vaporized thin metallic or oxide films or combinations thereof are generally employed as components for these structures.

Compared to metals and glass, advantages of polymers include their low weight and the small amount of material required. Also, especially due to the ecological concerns, the importance of the bio-based recyclable polymers is increasing significantly. However, due to polymers structure and permeability to gases and moisture they cannot meet very high barrier property requirements needed in some applications for example in high humidity and high temperature conditions. This is especially true for bio-based recyclable polymers.

To improve polymers barrier properties, they are often used in combination with other materials for example by application of thin films of aluminium, aluminium oxide or silicon oxide. However, also for these applications the permeation rates continue to be quite high for many applications especially for polymers based on renewable sources.

Many patents disclose inventions where multilayer structures are required to achieve appropriate barrier properties. These multilayer structures include for example metals and/or metal oxide barrier films, both biodegradable and non-biodegradable polymer films, and organic/inorganic composite films.

There are also known hybrid material compositions wherein properties of a biopolymer are modified with polysiloxane. Patent US2001/0056197A1 describes an invention concerning ormocers, which can be obtained by the hydrolytic condensation of one or more silicon compounds, a method for their production, and their use. The name ORMOCER is an abbreviation for “ORganically MOdified CERamics”. Hydrolytic polycondensation of an organofunctional silane with inorganic oxide components is a known method to produce scratchproof coating materials and achieve good barrier properties (e.g., DE3828098A1).

Patent publication JP2011195817 (A) presents a polylactic acid/silica based hybrid material which is obtained by forming a precursor with silane-coupling treatment of polylactic acid, and reacting the precursor with alkoxysilane, which after hybridization is carried out. US publication 2019062495 (A1) describes a method of producing silane-modified polyester blend by dissolving polyester and silane into organic solvent and permitting silane molecules to react with the polyester and/or undergo condensation with each other.

In patent publication US2011313114 (A1) there is presented a method in which polylactic acid is mixed with amino and/or epoxy-modified polysiloxane. The composition is produced in a melted state. Publication US2011313114 (A) presents a method of making polysaccharide graft polymers by reacting polysaccharide with antimicrobial agent comprising silane solution (silane, methanol, HCl and water).

Further prior art presented in JP2007076192 and CN105907098.

### SUMMARY OF THE INVENTION

The present invention aims at solving at least some of the problems of the prior art.

It is an object of the present invention to produce ecological and biodegradable or recyclable coating structures that have good barrier properties that are adequate for example for packaging of food, cosmetics etc. The material produced by the method of the present invention has a homogeneous chemical composition or structure and it is in some cases even transparent.

Thus, the present invention relates to a method for providing a new kind of biodegradable or recyclable chemical composition which is obtained by forming a polymetaloxane-biopolymer composition in a liquid state by mixing of biopolymer and metaloxane prepolymer, whichafter the composition is subjected to a curing step to form a hybrid material. The metaloxane prepolymer is prepared in the liquid state by hydrolyzation and condensation polymerization of the corresponding monomers in the presence of the biopolymer or provided as a ready-made prepolymer to be mixed with the biopolymer.

By mixing the at least partially condensed prepolymer and the biopolymer, and subjecting the prepolymer to a reaction with the biopolymer, a metaloxane-biopolymer composition is formed. As a result, a material is achieved which is generally homophasic.

Thus, in an embodiment, a modified polymetaloxane prepolymer is formed which is reacted with the biopolymer in order to achieve new kind of hybrid material composition.

In addition, the present invention concerns the composition obtained by the above described method and uses of such composition. The present invention also concerns coatings composed of the composition according to the invention.

In particular, the present invention is characterized by what is stated in the independent claims. Some specific embodiments are defined in the dependent claims.

Several advantages are reached using the present invention. Among others, the method of the invention provides a biodegradable or recyclable hybrid material composition with good barrier properties combined with biodegradability or recyclability. The invention also solves problems of polymer structures suffering from permeability to gases and moisture. The material composition of the present invention is generally homophasic and in some cases even transparent. The material composition can also be in the form of a self-standing film and/or object, and function as an adhesive for example for various microcellulose and clay compositions. Since the material is suitable to be used as a single layer, multi-layer structures are not required. Also, the problems related to microplastics can be avoided.

The material composition of the present invention is suitable to be used as a relatively thin barrier coating layer for both rigid and flexible packaging materials. By applying the composition of the present invention on bio-based, biodegradable, recyclable and/or compostable substrates, the present invention ensures the recyclability of the entire package in accordance with circular economy.

In one embodiment, the present invention provides a homogenous material which can be used as a barrier even in the form of a monolayer. In a further embodiment, the material can be used as a barrier in the form of a self-standing monolayer. According to another further embodiment the material can be used as a barrier in the form of a metal layer-free monolayer. Thus, the barrier material of the present invention provides sufficient barrier properties already as a monolayer, i.e. used as an only layer, i.e. without a multilayer structure usually comprising a metal layer.

The barrier coating produced by the method of the present invention can be applied with conventional coating techniques (spaying, brushing, rolling etc.). Simple methods are generally preferred, and no physical vaporization techniques are required.

### BRIEF DESCRIPTION OF THE DRAWINGS

FIGS. 1 to 3 show GPC (Gel permeation chromatography) measurements of a siloxane prepolymer (sample 1), reaction mixture of siloxane prepolymers and biopolymer (sample 2), and reaction mixture of siloxanes and biopolymer (sample 3) according to some embodiments the invention.

### EMBODIMENTS

In the present context, the term “metaloxane prepolymer” relates to a partially or completely condensed metaloxane polymer having at least one functional group capable to react with the biopolymer, which polymer may further comprise oligomeric or monomeric organic residues or segments.

The term “liquid state” in the present context also comprises a solution. Thus, according to the present invention, material is in a liquid state if it is a liquid as such, a melt achieved by heating the material above its melting temperature or dissolved, or at least dispersed, in a medium, preferably in a solvent.

Below, the terms “prepolymer solution” and “biopolymer solution” are used in general to describe the liquid state of the prepolymer and liquid state of the biopolymer, respectively. In these contexts, the term solution comprises all kinds of liquid states described above.

Hybrid material of the present invention is based on the interactions between the inorganic and organic species. In the material, the metaloxane prepolymer and the biopolymer reacts by forming chemical bonds, such as covalent bonds with each other.

Term “homophasic” in the present invention stands for a material of uniform composition throughout that cannot be mechanically separated into different materials.

The present invention concerns a method of forming a new kind of biodegradable or recyclable chemical composition which is formed by forming a polymetaloxane-biopolymer composition in a liquid state by mixing biopolymer and metaloxane prepolymer, after which the composition is subjected to a curing step to form a hybrid material.

According to one embodiment, the weight ratio between the biopolymer and the metaloxane prepolymer in the material composition is 1:99-99:1, for example 10:99 or 99:10 or 20:80 or 80:20 or 30:70 or 70:30 or 50:50.

The method of the present invention comprises mixing the metaloxane prepolymer and the biopolymer, both being in a liquid state. By mixing the at least partially condensed prepolymer with the biopolymer, and subjecting the prepolymer to a reaction with the biopolymer, a metaloxane-biopolymer composition in a liquid state is formed. As a result, a material is achieved which is generally homophasic.

According to one embodiment the obtained metaloxane-biopolymer composition in a liquid state is a liquid, a solution or a gel. Preferably, the composition of the present invention is clear, i.e. clear liquid, clear solution or clear gel.

At the first step of the present method, biopolymer is brought into liquid state. According to one embodiment, this is done by at least essentially dissolving the biopolymer into a solvent.

Preferably, the biopolymer is a water soluble polymer, wherein according to a preferred embodiment, the liquid phase of the biopolymer is provided as a water solution. Thus, no organic solvents are required.

According to another embodiment another solvent than water can be used, for example aqueous solvents, organic solvents or solvent mixtures.

According to one embodiment the biopolymer water solution is prepared by mixing the biopolymer and DI water preferably at a rounded bottom flask by stirring at room temperature. The stirring time may vary; typically it is less than an hour, preferably less than 30 minutes, for example about 15 minutes. Next, the mixture is preferably gradually heated to a temperature of about 50 to 100° C., for example about 90° C., and kept there typically for less than an hour, typically less than 30 minutes. Once a clear solution has been obtained, the hot mixture is filtrated, for example by using a 25 micron filter.

According to another embodiment, the liquid phase comprising the biopolymer is provided as a melt. The melt is obtained by heating the biopolymer above its melting temperature, typically in a round bottom flask at oil bath at about 80 to 100° C. The melting temperature of the biopolymer used in the present invention is typically in the range of 80-300° C., preferably in the range of 80-170° C., most preferably in the range of 80-100° C.

Biopolymers are materials which are produced from renewable resources such as agricultural feedstock, fatty acids, and organic waste. Biodegradable polymers are defined as materials that undergo deterioration and completely degrade when exposed to microorganisms, carbon dioxide processes, methane processes and/or water processes. Many bio-based polymers are biodegradable, however, nondegradable bio-based polymers exist. Furthermore, not all biodegradable polymers are bio-based, but oil-based biodegradable polymers exist.

Natural, bio-based polymers are the type of bio-based polymers which are found naturally, such as proteins, nucleic acids, and polysaccharides. Polymeric biomaterials can be classified into hydrolytically degradable polymers and enzymatically degradable polymers depending on their mode of degradation. Considering the present invention, biodegradable polymers are preferred and bio-based biodegradable polymers are the most preferred.

Bio-based polymers can be produced with three principal methods: (1) Partially modifying natural bio-based polymers (e.g., starch), (2) Producing bio-based monomers by fermentation/conventional chemistry followed by polymerization (e.g., polylactic acid) and (3) Producing bio-based polymers directly by bacteria (e.g. polyhydroxyalkanoate).

The biodegradable polymer of the present invention is derived for example from agricultural residues, wastes and crops but in some cases also oil-based biodegradable polymers can be used. Bio-based material can be for example a monomer derived polymer consisting of different building blocks such as alcohols, organic acids, alkenes etc.

According to a preferred embodiment the biopolymer used in the present method exhibits terminal OH groups and/or double bonds.

In the present context, the term “biodegradable”, when used in connection of a material, such as a biopolymer or hybrid material composition, and applied in particular to the organic part thereof, has the conventional meaning of the material being capable of degrading (breaking down) by the action of microorganisms, such as bacteria or fungi or both. Degradation can proceed through aerobic and anaerobic processes and will at the end typically yield carbon dioxide of the organic material. Biodegradation generally takes place in the present of water. Biodegrading the organic matter can be influenced by temperature and pH of the ambient and can take from days to months to even years to completion.

In embodiments, the present materials are biodegradable or recyclable or both. In embodiments, the organic part of the hybrid material is typically biodegradable which opens up for recovery of the non-organic part which typically can be recycled. Depending on the extent of biodegradability of the organic part, that part can also be at least partially recycled.

“Recyclability” stands for the capability of the material of being collected, typically sorted and aggregated into streams for recycling processes, and thus eventually becoming a raw material that can be used in the production of new products.

According to one embodiment of the present invention, the biopolymer is a biodegradable polymer material, such as a cellulose ester, like cellulose acetate (CA), a cellulose co-ester, like cellulose acetate butyrate (CAB), cellulose acetate phthalate (CAP), cellulose nitrate (CN), carboxymethyl cellulose (CMC), other ionic water-soluble celluloses, like sodium carbomethyl cellulose, other non-ionic cellulose, microcrystalline cellulose (MCC), microfibrillated cellulose (MFC), nanofibrillated cellulose (NFC), methyl cellulose (MC), hydroxyethyl cellulose (HEC), hydroxypropyl cellulose (HPC), hydroxypropyl methyl cellulose (HPMC); or polyvinylpyrrolidone (PVP); bio-based polybutylene succinate (BioPBS); polyhydroxy alkanoate (PHA); polyhydroxybutyrate (PHB); poly(3-hydroxyburate-co-3-3hydroxyvalerate) (PHBV); polylactic acid or polylactide (PLA);

polyglycolic acid or polyglycolide (PGA); starch; chitosan; xylan; lignin or a combination of two or more of the foregoing polymer materials.

According to another embodiment of the present invention, the biopolymer is a fossil-based polymer material, such as poly(butylene adipate) (PBA), polybutylene adipate terephthalate (PBAT), poly(butylene succinate) (PBS), poly(butylene succinate-adipate) (PBSA), poly(butylene sebacate) (PBSE), poly(ethylene adipate) (PEA), poly(ethylene succinate) (PES), poly(ethylene succinate-coadipate) (PESA), poly(ethylene sebacate) (PESE), poly(ortho ester) (POE), polyphosphazenes (PPHOS), poly(propylene succinate) (PPS), poly(tetramethylene adipate) (PTA), poly(tetramethylene succinate) (PTMS), poly(tetramethylene sebacate) (PTSE), poly(trimethylene terephthalate (PTT), polyanhydrides, poly(butylene succinate-co-lactide) (PBSL), poly(butylene succinate-co-terephthalate) (PBST), polybutylene adipate-co-terephthalate (PBAT), polycaprolactone (PCL), polymethylene adipate/terephthalate (PTMAT), poly(vinyl alcohol) (PVOH, PVA, or PVAl), polydioxanone (PDS), polyglycolide or poly(glycolic acid) (PGA) and/or polyethylene glycol (PEG).

According to preferred embodiment, the biopolymer is selected from the group of polyvinyl alcohol, polylactic acid, polylactide, polyglycolic acid, polyglycolide, polybutylene succinate, polyhydroxy alkanoate, polyhydroxybutyrate, and combinations thereof.

According to one embodiment, the biopolymer is a polyester. Preferably, the polyester is selected from the group of polylactic acid, polylactide, polyglycolic acid, polyglycolide, polybutylene succinate, polyhydroxy alkanoate, polyhydroxybutyrate, and combinations thereof. Polyesters are poorly soluble in water. Therefore, according to a preferred embodiment polyesters are used as a melt.

According to another embodiment polyesters can be used in a liquid state by using a solvent, preferably other than water, such as an organic solvent.

According to one embodiment the concept of biopolymer in the present invention also comprises bio-mono-, di- and oligomers that can be derived from biopolymer or that act as building blocks of biopolymers. As an example a mention can be made of L-lactide.

One or more different biopolymers may be used in the present invention. For example, two different biopolymer solutions can be combined. If more than one biopolymer solutions are used, the solutions are usually combined prior mixing with the metaloxane prepolymer by stirring at room temperature.

According to one embodiment, a biopolymer solution formed by polyester is combined with other biopolymer solution, such as biopolymer solution based on cellulose or lignin biopolymer. Addition of cellulose or lignin biopolymer, to a polyester biopolymer, can improve the mechanical properties and thermal stability of polyesters.

The metaloxane prepolymer used in the present method is prepared in a liquid state by hydrolyzation and condensation polymerization of the corresponding monomers. The metaloxane prepolymer can be provided as a ready-made prepolymer into the mixture of the prepolymer and the biopolymer, or the prepolymer can be prepared in a liquid state in the presence of the biopolymer, i.e. in situ.

Thus, the next step of the present method is to provide the metaloxane prepolymer or metaloxane in a liquid state. Metaloxane monomers may also be added as such into the liquid phase of the biopolymer. In the case of adding metaloxane solution or metaloxane monomers into the biopolymer being in a liquid state, the metaloxane prepolymer is formed in situ in the liquid state of the biopolymer, for example in a biopolymer solution.

As presented above, the biopolymer being in a liquid state may be a liquid as such, a melt achieved by heating the material above its melting temperature or a solution i.e. dissolved, or at least dispersed, in a medium, preferably in a solvent.

According to one embodiment a metaloxane solution is formed by mixing one or several different metaloxane monomers at room temperature, typically for less than an hour, for example for about 15 minutes. The mixture can be diluted, for example with 1-propanol.

According to another embodiment a metaloxane prepolymer is formed by mixing one or several different metaloxane monomers at room temperature, typically for less than an hour, for example for 15 minutes. Typically, a catalyst is added and the stirring is continued for several hours. The mixture can be diluted.

Also different prepolymers can be used, wherein the prepolymer solutions are preferably combined prior to mixing with the biopolymer. According to another embodiment a further prepolymer solution can be added into the already mixed prepolymer-biopolymer composition.

The method of the present invention comprises mixing the biopolymer with the polymetaloxane prepolymer. According to one embodiment the polymetaloxane prepolymer, metaloxane solution or metaloxane monomers in liquid state are gradually added into the biopolymer being in liquid state, i.e. in a biopolymer liquid, melt or solution. Preferably, the liquid phase is agitated, in particularly vigorously agitated, during the addition or formation of the polymetaloxane prepolymer.

According to one embodiment the mixture of the metaloxane prepolymer and the biopolymer can be stirred at room temperature. According to another embodiment, the stirring is carried out at elevated temperature of about 60 to 100° C., for example about 80 to 90° C.

According to one embodiment the gradual addition of the polymetaloxane prepolymer, metaloxane solution or metaloxane monomers to the liquid phase of the biopolymer forms a colloidal liquid solution.

The polymetaloxane prepolymer is a polymer formed in liquid state by hydrolyzation and condensation polymerization of the corresponding monomers in order to obtain a polymer having a metaloxane backbone formed by repeating-metal-O— units. The properties, such as molecular weight, of the prepolymer are controlled by the hydrolyzation and condensation conditions. Typically, the molecular weight, i.e. the weight average molar mass, of the produced prepolymer is 1000 to 100 000 g/mol, in particular 2000 to 20 000 g/mol measured by GPC (Gel permeation chromatography), against a polystyrene standard. By varying the conditions, different structures, such as linear, more branched and branched structures, are formed. The condensation degree of the prepolymer can also be adjusted to an appropriate level.

According to one embodiment pH and temperature conditions can be used to affect the properties of the prepolymer. Generally, alkaline conditions favor condensation over hydrolysis. By changing the pH conditions and temperature, it is possible to “manipulate” the metaloxane compound structure and its reactivity. For example, more OH-groups can be introduced into the structure to increase the reactivity of the compound. The adjustment of pH and temperature can be done prior, during or after combining the metaloxane component and the biopolymer.

According to one embodiment, the polymetaloxane prepolymer is selected from the groups of siloxane, germanoxane, aluminoxane, titanoxane, zirconoxane, ferroxane and stannoxane prepolymers and formed by hydrolyzing and at least partially condensating the corresponding monomers.

According to one embodiment at least 20 mol-%, in particular at least 40 mol-%, for example 50 to 99 mol-% of the corresponding monomers are hydrolyzed and condensated to form a polymetaloxane prepolymer.

The hydrolysis and condensation of the corresponding monomers is performed in acidic, alkaline or neutral conditions.

According to a preferred embodiment the hydrolysis and condensation is performed in the presence of acid, preferably organic acid.

According to a further preferred embodiment, the organic acid comprises monomeric organic acids, wherein the biopolymer is coupled to the metaloxane prepolymer at least partially using these monomeric organic acids. Thus, the organic acid may be bound to the polymer backbone, wherein no harmful acids remain free.

According to an even further preferred embodiment, the organic acid used is multifunctional, in particular difunctional. Such an acid can react from its both ends with the prepolymer and/or the biopolymer. Preferably, the organic acid has groups capable of reacting with terminal groups of at least the biopolymer.

According to one embodiment, the organic acid monomers react with the monomers corresponding to the metaloxane polymer, and thus becomes part of the formed metaloxane prepolymer.

Thus, according to one embodiment, the prepolymer is formed in the presence of an acid selected from the group of inorganic acids, comprising nitric acid, hydrochloric acid, sulfuric acid, phosphoric acid and boric acid, or from the group of organic acids, comprising lactic acid, acetic acid, formic acid, citric acid, oxalic acid, uric acid, itaconic acid, fumaric acid, succinic acid, gluconic acid, glutamic acid, malic acid, maleic acid, 2,5-furan dicarboxylic acid, 3-Hydroxypropionic acid, glucaric acid, aspartic acid, levulinic acid and combinations thereof.

According to a preferred embodiment, the prepolymer is formed in the presence of an acid selected from the group of difunctional acids, in particular from the group of difunctional acids comprising nitric acid, phosphoric acid, sulfuric acid, lactid acid, citric acid, oxalic acid, fumaric acid, succinic acid, gluconic acid, glutamic acid, malic acid, maleic acid, 2,5-furan dicarboxylic acid, 3-hydroxypropionic acid, glucaric acid, aspartic acid, levulinic acid and combinations thereof.

Preferably, the difunctional acid is selected from the group of levulinic acid, succinic acid, malic acid and combinations thereof. Levulinic acid, succinic acid and malic acid are difunctional acids having both hydroxyl and carboxyl group. Therefore, these acids can efficiently react through the two different types of preferable functional groups and alter the properties of the produced molecule/(pre)polymer.

According to one embodiment diluted acids having a pH in the range of 0 to 7, preferably 1 to 6, most preferably 2 to 3.

One or more organic acids can be used at the same time. According to one embodiment, at least one organic acid is difunctional. According to another embodiment at least two, for example 2 to 4 organic acids are difunctional. According to a further embodiment the difunctional acid or difunctional acids are used in combination with one or more monofunctional acids.

According to one embodiment at least 50 mol-% of the organic acids are difunctional.

According to a preferred embodiment the prepolymer formed in the presence of an acid listed above comprises a polysiloxane.

The metaloxane prepolymer is typically formed at a temperature of 20 to 90° C. The hydrolyzation which occurs prior to the condensation can further be limited by adjusting the temperature and pH of the solution. Thus, the polymerization degree of the metaloxane monomers can be adjusted with temperature and pH of the reaction conditions. Typically, the temperature is in the range of 20 to 80° C. and the pH is in the range of 1 to 5, for example 1.5 to 4. According to another embodiment, the pH is in the range of 8 to 12.

According to one embodiment the method of the present invention comprises in situ formation of the polymetaloxane prepolymer in the presence of the biopolymer. Thus, the present method may comprise the step of combining the biopolymer with one or more metaloxane monomers to form a colloidal solution.

According to an embodiment the metaloxane monomers used to form the prepolymer, either prior to the mixing with the biopolymer or in the presence of the biopolymer, are selected from the group of 3-glycidoxypropyl-trimethoxysilane (GPTMS), bis(triethoxysilyl)ethane (BTESE), methyltrimethoxysilane (MTMS), Phenyltrimethoxysilane (PTMS) and (3-aminopropyl)triethoxysilane (APTES), and combinations thereof.

According to another embodiment the metaloxane monomers used to form the prepolymer, either prior to mixing with the biopolymer or in the presence of the biopolymer, are selected from the group of triethoxysilane, ethyltriethoxysilane, methyltrimethoxysilane, methyltriethoxysilane, tetraethoxysilane, tetramethoxysilane, dimethyldiethoxysilane, dimethyldimethoxysilane, methyldiethoxyvinylsilane, 1,2-bis(triethoxysilyl)ethane, vinyltrimethoxysilane, vinyltriethoxysilane, vinylmethyldimethoxysilane, phenyltrimethoxysilane, n-butyltriethoxysilane, n-octadecyltriethoxysilane, acryloxypropyl-trimethoxysilane, allyltrimethoxysilane, aminopropyltrimethoxysilane, methacryloxypropyltriethoxysilane, methacryloxypropyltrimethoxysilane, phenantrene-9-triethoxysilane, 3-glysidoxypropyltrimethoxysilane, diphenylsilanediol, 1,2-bis(trimethoxysilyl)methane, 1,2-bis(trimethoxysilyl)ethane, epoxycyclohexylethyltrimethoxysilane, 1-(2-(Trimethoxysilyl)ethyl)cyclohexane-3,4-epoxide, (Heptadecafluoro-1,1,2,2-tetra-hydrodecyl)trimethoxysilane, trimethoxy(3,3,3-trifluoropropyl)silane, 1H, 1H, 2H, 2H-perfluorodecyltrimethoxysilane, glycidylmethacrylate and mixtures thereof. These can be used alone, in combination with each other or together with the above mentioned metaloxane monomers.

According to one embodiment at least part of the metaloxane monomers are monomers with a functional groups. Preferably at least 50 mol-%, preferably at least 70 mol-%, more preferably at least 90 mol-%, of the monomers have a functional group.

According to one embodiment, at least 50 mol-%, preferably at least 70 mol-%, more preferably at least 90 mol-%, of the metaloxane monomers are selected from the group of 3-glycidoxypropyl-trimethoxysilane (GPTMS), bis(triethoxysilyl)ethane (BTESE), methyltrimethoxysilane (MTMS), Phenyltrimethoxysilane (PTMS) and (3-aminopropyl)triethoxysilane (APTES) and combinations thereof.

According to one embodiment all of the metaloxane monomers are selected form the froup of 3-glycidoxypropyl-trimethoxysilane (GPTMS), bis(triethoxysilyl)ethane (BTESE), methyltrimethoxysilane (MTMS), Phenyltrimethoxysilane (PTMS) and (3-aminopropyl)triethoxysilane (APTES) and combinations thereof.

According to one embodiment the metaloxane monomers always comprise at least one dipodal monomer, preferably BTESE silane monomer. As a bis-silyl functional silane, BTESE has six hydrolysable groups and hence, may be more crosslinked than tri- and tetra-functional analogues. Obtained crosslinking sites may lead to better barrier properties, for example. In addition, unique structure of BTESE enable sit to have an improved adhesion and weather resistance. According to one embodiment, at least 20 mol-%, preferably at least 50 mol-%, of the metaloxane monomers are of BTESE monomer type.

According to one embodiment GPTMS can be used as a metlaoxane monomer. GPTMA is an epoxy-functional silane which is particularly employed as an adhesion-promoting additive, wherein it eliminates the need for a separate primer. GPTMS has possibility for various reactions via its epoxy group. According to further embodiment GPTMS can be combined with APTES, wherein a resin-based material is formed.

According to another embodiment MTMS can be used alone or together with other metaloxane monomers. MTMS is one of the most common alkoxy crosslinkers, due to its high reactivity. The reaction proceeds by nucleophilic substitution, usually in the presence of acid or base catalysts. Alkoxides react directly with silanols or with water to produce silanols. The newly formed silanols can react with other alkoxides or self-condense to produce a siloxane bond and water. When an acid catalyst is used, protonation of the alkoxysilane increases the reactivity of the leaving group. When a base catalyst is used, deprotonation of the silanol forms a reactive silonate anion. Both, acid and base catalysts, can be used in the present invention in order to prepare prepolymers with various molecular weights. MTMS is highly miscible with standard organic solvents

According to one embodiment PTMS can be used alone or together with other metaloxane monomers. PTMS contains a phenyl group that exhibits excellent thermal stability and provides flexibility to the system. All three alkoxy groups can be hydrolysed, wherein tough and highly hydrophobic materials can be obtained. PTMS is especially suited for polymers that are processed at elevated temperatures because it reduces the viscosity of the polymer melt.

According to one embodiment APTES can be used alone or together with other metaloxane monomers. APTES is a versatile amino-functional coupling agent used over a broad range of applications to provide superior bonds between inorganic substrates and organic polymers. The silicon-containing portion of the molecule provides strong bonding to substrates. The primary amine function reacts with several thermosets, thermoplastics, and elastomeric materials. In the present invention APTES reacts with a biopolymer suitable site. Amine group of APTES can for example react with the carbonyl group of the biopolymer or with the ortho position of a free phenolic hydroxyl group of lignin.

There can be used only one type or metaloxane monomers or a mixture of two or more different metaloxane monomers. Preferably, the metaloxane prepolymer is formed from a mixture of metaloxane monomer comprising at least two different metaloxane monomers.

The combination of metaloxane monomers defines the structure (linear or branched) of the obtained hybrid material.

According to one embodiment of the present invention, in addition to metaloxane prepolymer corresponding dimers or monomers can be used in the composition. The dimers typically having a molecular weight, i.e. weight average molar mass, of 500 to 2000 g/mol measured by GPC (Gel permeation chromatography), against a polystyrene standard.

According to a preferred embodiment, the biopolymer is chemically coupled, in particular crosslinked, with the metaloxane prepolymer during the method of the present invention. This is achieved by modifying the prepolymer such that it comprises reactive groups.

According to a preferred embodiment, the metaloxane prepolymer of the present invention is siloxane prepolymer which is formed by hydrolysing the hydrolysable groups of the silane monomers and then further at least partially polymerising it by a condensation process.

The hybrid material composition of the present invention is obtained from the polymetaloxane-biopolymer composition by a curing step.

The curing step is a chemical process that produces the toughening or hardening of the polymer hybrid material composition by chemically coupling of the metaloxane prepolymer and the biopolymer. The curing step can be initiated for example by heat, radiation, electron beams or chemical additives.

According to one embodiment the curing step is performed by increasing the temperature of the composition, adding a catalyst to the composition or adjusting the pH of the composition, or by combining two or all of the said options.

According to one embodiment, a catalyst is used in a curing step of the composition. Preferably, the catalyst composition used comprises metal alkoxides, such as magnesium isopropoxide, calcium isopropoxide, aluminum isopropoxide, titanium isopropoxide, zirconium isopropoxide, titanium acetylacetonate, titanium butoxide, aluminium lactate, iron lactate and zinc lactate, or non-metal alkoxides, or oxides, such as zinc oxide, titanium oxide and tin oxide, or non-metal octoate complexes, such as zinc octoate, germanium octoate, iron octoate and tin octoate.

According to one embodiment the method of the present invention comprises forming one or more biopolymer solutions which are combined, forming a metaloxane prepolymer solution and combining the biopolymer solution and the metaloxane solution, and then subjecting the obtained composition to a curing step.

The present invention also concerns a biodegradable or recyclable hybrid material composition obtained by the above described method. According to one embodiment the material composition is homogeneous. In one embodiment, the material composition, preferably a homogeneous composition, is transparent, translucent or opaque.

The material composition of the present invention can be used as a single layer or as one or several layers of a multi-layered coating, preferably on a bio-based substrate to obtain a recyclable package or article.

“Bio-based substrates” are materials generally obtained from biological materials, such as biomass (e.g. carbohydrate materials, lignocellulosic materials, in particular in the form of fibrous materials), proteinaceous materials, and lipid-containing materials and combinations thereof. Typically, such materials can be biodegradable, recyclable and/or compostable. Specific examples of bio-based substrates include fibrous sheets, webs or objects, in particular sheets or webs of cellulosic or lignocellulosic materials, such as papers and paperboards. Other materials that can be shaped into sheets or webs can also be coating, such materials for example comprising biopolymers, in particular thermoplastic polymers (for example polyesters), such as polylactic acid, polylactide, polyglycolide, polycaprolactone, polyhydroxyalkanoates, such as polyhydroxybutyrate, as well as copolymers of the monomers forming one or several of the foregoing polymers.

In addition, the present invention concerns a coating that is composed of the material composition according to the invention, which coating can be homogeneous. The coating can be used as a self-standing coating as well and it can have a thickness of 0.01 to 1000 μm, for example 0.05 to 500 μm, such as 0.1 to 250 μm. In one embodiment, the thickness is about 1 to 200 μm, for example about 2 to 150 μm or 5 to 100 μm.

The coating of the present invention may be applied by any conventional methods, such as by spraying, brushing, rolling or curtain coating. According to embodiment the coating can be applied by a contactless method, i.e. without contacting the surface to be coated.

It is to be understood that the embodiments of the invention disclosed are not limited to the particular structures, process steps, or materials disclosed herein, but are extended to equivalents thereof as would be recognized by those ordinarily skilled in the relevant arts.

It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1

Solution 1—Preparation of Biodegradable Polymer Water Solution

DI water, 376 g, was added to 24 g of Poval 25-98R powder (PVA), weighed into a round bottom flask. The mixture was stirred at room temperature for 15 minutes. After a homogeneous, foggy solution was obtained, the round bottom flask was equipped with condenser and placed on oil bath. The mixture was heated gradually to 90° C. during 45 minutes, and kept at 90° C. for 15 minutes. After a clear solution was obtained, the hot mixture was filtrated by using 25 micron filter.

Solution 2—Preparation of Biodegradable Polymer Water Solution

DI water, 376 g, was added to 24 g of Exeval HR3010 powder (PVOH), weighed into a round bottom flask. The mixture was stirred at room temperature for 15 minutes. After a homogeneous, foggy solution was obtained, the round bottom flask was equipped with a condenser and placed on oil bath. The mixture was heated gradually to 90° C. during 45 minutes, and kept at 90° C. for 15 minutes. After a clear solution was obtained, the hot mixture was filtrated by using 25 micron filters.

Solution 3—Preparation of Biodegradable Polymer Mixture

Solution 1 (75 g) and solution 2 (225 g) were combined into a round bottom flask, and stirred at room temperature for 15 minutes. To the clear mixture, 1.68 g of acetic acid was added slowly by using a dropping funnel. The reaction mixture was stirred at room temperature for 1 h.

Solution 4—Preparation of Siloxane Solution

BTESE (2.65 g, 0.0075 mol), MTMS (0.25 g, 0.0018 mol) and GPTMS (3.78 g, 0.0160 mol) were weighed into a round bottom flask. The monomer mixture was stirred at room temperature for 15 minutes, and diluted by 1-propanol (6.63 g)

Solution 5—Preparation of Final Material

Solution 4 was added dropwise to solution 3, placed on oil bath. The reaction mixture was warmed up to 88° C. and kept on stirring for 1 h. The clear solution obtained was overnight stirring at room temperature. After cooling down, the mixture was diluted by using EtOH (40 g, 60%).

### Example 2

Solution 1—Preparation of Biodegradable Polymer Water Solution

Prepared as the corresponding solution in example 1.

Solution 2—Preparation of Biodegradable Polymer Water Solution

Prepared as the corresponding solution in example 1.

Solution 3—Preparation of Polysiloxane Prepolymer

BTESE (20.0 g, 0.05640 mol), GPTMS (105.0 g, 0.44428 mol) and 2-propanol (51 g) were weighted into a round bottom flask. The monomer mixture was stirred at room temperature for 15 minutes, then 0.01M of nitric acid (26.9 g) was added dropwise at room temperature during 15 minutes. The reaction mixture was stirred at room temperature for 3 hours, and diluted by 2-propanol (100.0 g).

The molecular weight of the polymer was in the range 1000-20 000 g/mol based on Gel Permeation Chromatography (GPC) measurement.

Solution 4—Preparation of Final Material

Solution 1 (5 g) and solution 2 (10 g) were combined into a round bottom flask, and stirred at room temperature for 15 minutes. To the clear mixture, 1.14 g of Sivo 140; 0.85 g of solution 3; 0.19 g of Coatosil 200, and 0.76 g of 1-propanol were added at room temperature.

The reaction mixture was stirred at room temperature for 15 min. in the flask, equipped with a reflux condenser, and transferred to an oil bath. The mixture was heated gradually to 88° C. during 45 minutes, and kept at 88° C. for 60 minutes. After a clear solution was obtained, the hot mixture was cooling down by stirring at room temperature during 12 hours, and filtrated by using a 0.45 PTFE filter.

### Example 3

Solution 1—Preparation of Biodegradable Polymer Water Solution

Prepared as the corresponding solution in example 1.

Solution 2—Preparation of Biodegradable Polymer Water Solution

Prepared as the corresponding solution in example 1.

Solution 3—Preparation of Final Material

Solution 1 (5 g) and solution 2 (10 g) were combined into a round bottom flask, and stirred at room temperature for 15 minutes. To the clear mixture, 0.6 g of 1-propanol; 0.03 g (0.00016 mol) of MTEOS; and 0.15 g of propylene carbonate were added at room temperature.

The reaction mixture was stirred at room temperature for 15 min. in the flask, equipped with reflux condenser, and transferred to an oil bath. The mixture was heated gradually to 88° C. during 45 minutes, and kept at 88° C. for 60 minutes. After a clear solution was obtained, the hot mixture was cooling down by stirring at room temperature during 12 hours, and filtrated by using a 0.45 PTFE filter.

### Example 4

Preparation of Part A

Solution 1A—Preparation of Biodegradable Polymer Water Solution

Prepared as the corresponding solution in example 1.

Solution 2A—Preparation of Biodegradable Polymer Water Solution

Prepared as the corresponding solution in example 1.

Solution 3A—Preparation of Polysiloxane Prepolymer

BTESE (20.0 g, 0.05640 mol), GPTMS (105.0 g, 0.44428 mmol) and 2-propanol (51.0 g) were weighed into a round bottom flask. The monomer mixture was stirred at room temperature for 15 minutes, then 0.01M of nitric acid (26.9 g) was added dropwise at room temperature during 15 minutes. The reaction mixture was stirred at room temperature for 3 hours, and diluted by 2-propanol (100.0 g).

Solution 4A—Preparation of Part a Final Material

Solution 1 (5 g) and solution 2 (10 g) were combined into a round bottom flask, and stirred at room temperature for 15 minutes. To the clear mixture, 0.15 g of Coatosil 200; 0.67 g of solution 3; 0.15 g of Propylene carbonate, and 0.60 g of 1-propanol were added at room temperature. The reaction mixture was stirred at room temperature for 15 min.

Preparation of Part B

Solution 1B—Preparation of polysiloxane prepolymer

APTES (30.3 g, 0.1369 mol), and 2-propanol (9.16 g) were weighed into a round bottom flask and stirred at room temperature for 15 minutes. Then 0.01M of nitric acid (5.52 g) was added dropwise at room temperature during 30 minutes. The reaction mixture was stirred at room temperature for 12 hours, and diluted with PGME (30.0 g) to a solid content of 33%.

Solution 2B—Preparation of Part B Final Material

To 0.6 g of solution 1B, an amount of 0.1 g of Carbosil 530 was added. The mixture thus obtained was stirred at room temperature for 1 hour.

Preparation of Final AB Material

Solution 4A was combined with Solution 2B at room temperature, and stirred for 2 hours.

### Example 5

Solution 1—Preparation of L-Lactide

L-lactic acid (50 g, 0.56 mol) were weighed into a round bottom flask and stirred at 175° C. for 3 hours. Then 0.1 wt % of solid tin oxide catalyst was added and the temperature was raised to 230° C. L-lactide formed was separated from the mixture by vacuum of 5 mbar. Pure solid L-lactide was melted down by heating in a round bottom flask at 100° C. on oil bath.

L-lactide can be derived from L-lactic acid as described; commercial L-lactide is as well suited.

Solution 2—Preparation of Polysiloxane Prepolymer 1

GPTMS (14.0 g, 0.0592 mol) and 2-propanol (1.0 g) were weighed into a round bottom flask. The mixture was stirred at room temperature for 15 minutes; then 0.01M of nitric acid (3.19 g) was added dropwise at room temperature during 15 minutes. The reaction mixture was stirred at room temperature for 3 hours.

Solution 3—Preparation of Polysiloxane Prepolymer 2

APTES (30.3 g, 0.1369 mol), and 2-propanol (9.16 g) were weighed into a round bottom flask and stirred at room temperature for 15 minutes; then 0.01M of nitric acid (5.52 g) was added dropwise at room temperature during 30 minutes. The reaction mixture was stirred at room temperature for 12 hours, and diluted with PGME (30.0 g) to a solids content of 33%.

Solution 4—Preparation of Final Material

Solution 2 (2 g) and solution 3 (0.5 g) were combined into a round bottom flask, and added dropwise to solution 1 (2 g) placed on oil bath. After addition, the mixture was heated to 110° C., kept at 110° C. for 5 minutes and cooled down to room temperature by stirring on oil bath. A clear yellow liquid was obtained.

### Example 6

Solution 1—Preparation of PLA

Solid material was melted down by heating in a round bottom flask at 80° C. on oil bath.

Solution 2—Preparation of Polysiloxane Prepolymer 1

GPTMS (14.0 g, 0.0592 mol) and 2-propanol (1.0 g) were weighed into a round bottom flask. The mixture obtained was stirred at room temperature for 15 minutes; then 1% of CH₃COOH (3.19 g) was added dropwise at room temperature during 15 minutes. The reaction mixture was stirred at room temperature for 3 hours.

Solution 3—Preparation of Polysiloxane Prepolymer 2

APTES (30.3 g, 0.1369 mol), and 2-propanol (9.16 g) were weighed into a round bottom flask and stirred at room temperature for 15 minutes; then 1% of CH₃COOH (5.52 g) was added dropwise at room temperature during 30 minutes. The reaction mixture was stirred at room temperature for 12 hours, and diluted with PGME (30.0 g) to a solids content of 33%.

Solution 4—Preparation of Final Material

Solution 2 (5 g) and solution 3 (1.6 g) were combined into a round bottom flask, and added dropwise to solution 1 (7 g) placed on oil bath. After addition, the mixture was heated to 110° C., kept on 110° C. for 5 minutes and cooled down to room temperature by stirring on oil bath. A clear yellow liquid was obtained.

### Example 7

Solution 1—Preparation of PLA

Solid material was melted down by heating in a round bottom flask at 80° C. on oil bath.

Solution 2—Preparation of Polysiloxane Prepolymer 1

GPTMS (14.0 g, 0.0592 mol) and 2-propanol (1.0 g) were weighed into a round bottom flask. The mixture was stirred at room temperature for 15 minutes. Then 1% of CH₃COOH (5.52 g) was added dropwise at room temperature during 15 minutes. The reaction mixture was stirred at room temperature for 3 hours.

Solution 3—Preparation of Polysiloxane Prepolymer 2

APTES (30.3 g, 0.1369 mol), and 2-propanol (9.16 g) were weighed into a round bottom flask and stirred at room temperature for 15 minutes. Then 1% of CH₃COOH was added dropwise at room temperature during 30 minutes. The reaction mixture was stirred at room temperature for 12 hours, and diluted with PGME (30.0 g) to a solids content of 33%.

Solution 4—Preparation of Polysiloxane Prepolymer 3

BTESE (Bis(Triethoxysilyl)ethane, 5.6 g, 0.01579 mol), acetone (5.6 g), and 2-propanol (1.40 g) were weighed into a round bottom flask. An amount of 1.32 g of 1% CH₃COOH was added dropwise at room temperature during 15 minutes. The reaction mixture was stirred at room temperature for 5 hours.

Solution 5—Preparation of Final Material

Solution 2 (5 g), solution 3 (1.6 g), and solution 4 (0.8 g) were combined into a round bottom flask, and added dropwise to solution 1 (7 g) placed on oil bath. After addition, the mixture was heated to 110° C., kept at 110° C. for 5 minutes, and cooled down to room temperature by stirring on oil bath. A clear yellow liquid was obtained

### Example 8

Solution 1—Preparation of PLA

Solid material was melted down by heating in a round bottom flask at 80° C. on oil bath.

Solution 2—Preparation of Polysiloxane Prepolymer 1

BTESE (Bis(Triethoxysilyl)ethane, 5.6 g, 0.01579 mol), acetone (5.6 g), and 2-propanol (1.40 g) were weighed into a round bottom flask. An amount of 1.32 g of 1% CH₃COOH was added dropwise at room temperature during 15 minutes. The reaction mixture was stirred at room temperature for 5 hours.

Solution 3—Preparation of Final Material

Solution 2 (6 g), was added dropwise to solution 1 (5 g) placed on oil bath. After addition, the mixture was heated to 110° C., kept at 110° C. for 5 minutes. A clear gel material was obtained.

### Example 9

Solution 1—Preparation of PLA

Solid material was melted down by heating in a round bottom flask at 80° C. on oil bath.

Solution 2—Preparation of Polysiloxane Prepolymer 1

BTESE (Bis(Triethoxysilyl)ethane, 5.6 g, 0.01579 mol)), acetone (5.6 g), and 2-propanol (1.40 g) were weighed into a round bottom flask. An amount of 1.32 g of 1% biosuccinum water solution was added dropwise at room temperature for 15 minutes. The reaction mixture was stirred at room temperature for 5 hours.

Solution 3—Preparation of Polysiloxane Prepolymer 2

PTMS (Phenyltrimethoxysilane, 14.00 g, 0.07060 mol) was weighed into a round bottom flask. An amount of 3.81 g of 1% CH₃COOH was added dropwise at room temperature for 15 minutes. Reaction mixture was stirred at room temperature for 5 hours.

Solution 4—Preparation of Final Material

Solution 2 (0.48 g) and solution 3 (4.47 g) were added dropwise to solution 1 (4.75 g) placed on oil bath. After addition, the mixture was heated to 110° C., kept at 110° C. for 5 minutes, and cooled down to room temperature. A clear liquid material was obtained.

### Example 10

Solution 1—Preparation of PLA

Solid material was melted down by heating in a round bottom flask at 80° C. on oil bath.

Solution 2—Preparation of Polysiloxane Prepolymer 1

BTESE (Bis(Triethoxysilyl)ethane, 5.6 g, 0.01579 mol), acetone (5.6 g), and 2-propanol (1.40 g) were weighed into a round bottom flask. An amount of 1.32 g of Malic acid was added dropwise at room temperature during 15 minutes. The reaction mixture was stirred at room temperature for 5 hours.

Solution 3—Preparation of Final Material

Solution 2 (3.2 g), was added dropwise to solution 1 (10.02 g) placed on oil bath. After addition, the mixture was heated to 110° C., and kept at 110° C. for 5 minutes. A clear gel material was obtained.

### Example 11

Solution 1—Preparation of PLA

Solid material was melted down by heating in a round bottom flask at 80° C. on oil bath.

Solution 2—Preparation of Polysiloxane Prepolymer 1

BTESE (Bis(Triethoxysilyl)ethane, 5.6 g, 0.01579 mol), acetone (5.6 g), and 2-propanol (1.40 g) were weighed into a round bottom flask. An amount of 1.32 g of Maleic acid was added dropwise at room temperature for 15 minutes. The reaction mixture was stirred at room temperature for 5 hours.

Solution 3—Preparation of Final Material

Solution 2 (3.2 g), was added dropwise to solution 1 (10.02 g) placed on oil bath. After addition, the mixture was heated to 110° C. and kept at 110° C. for 5 minutes. A clear gel material was obtained.

### Example 12

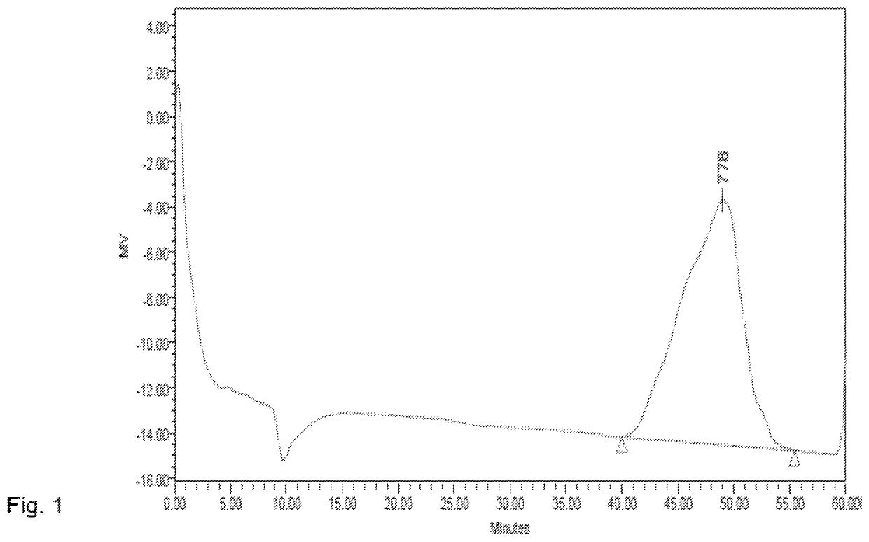

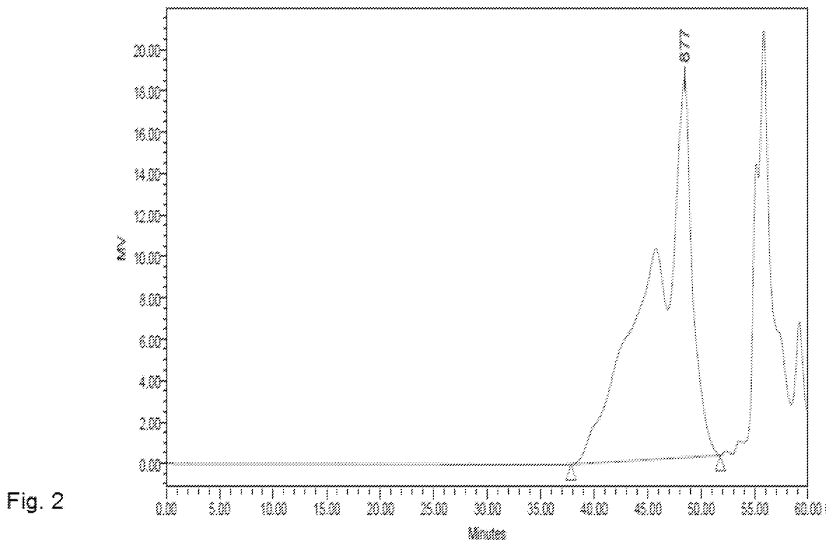

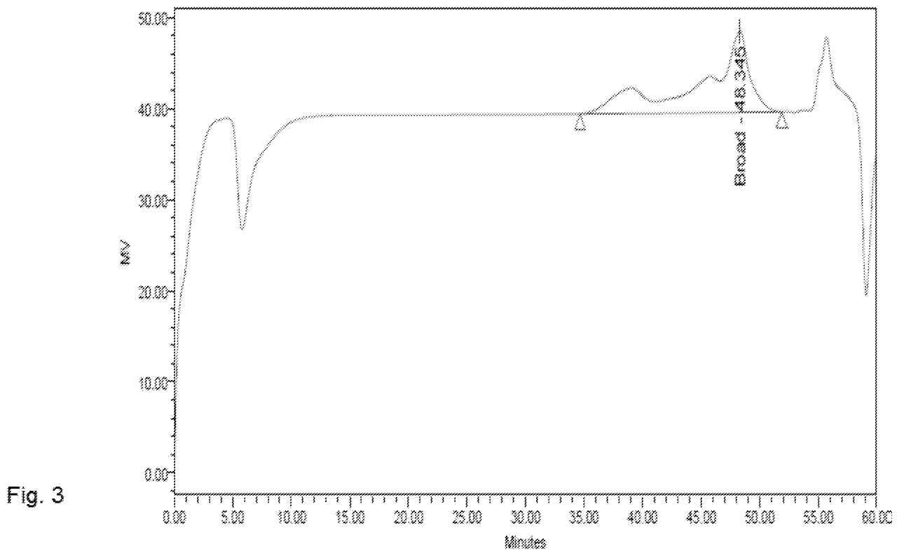

Gel permeation chromatography (GPC) measurements were performed for a siloxane prepolymer (sample 1), reaction mixture of siloxane prepolymers and biopolymer (sample 2), and reaction mixture of siloxanes and biopolymer (sample 3) according to some embodiments of the invention. The obtained average molecular weight (Mw) results are shown in table 1 and the GPC graphs are presented in FIGS. 1 to 3.

Sample 1 is a GPTMS prepolymer which was hydrolysed and condensed with biosuccinum acid.

Sample 2 is a reaction mixture of melted Lactide and BTESE/PTMS prepolymers. BTESE was prepared by condensing with biosuccinum acid, and PTMS with CH₃COOH.

Sample 3 is a reaction mixture of Lactide and PTMS siloxane which was hydrolysed and condensed with CH₃COOH in the presence of Lactide to form a prepolymer.

TABLE 1
Average molecular weights of the samples.

| Sample | Mw (g/mol) |
|---|---|
| 1 | 1574 |
| 2 | 3018 |
| 3 | 2228 |

### INDUSTRIAL APPLICABILITY

The present method can be used to produce biodegradable or recyclable hybrid material composition, and generally for replacement of conventional methods of producing hybrid material compositions.

In particular, the present hybrid material composition is useful in coating applications. Especially, the composition can be used as a single layer coating on a biobased substrate. The composition can be used for example as coating of flexible and rigid substrates and in packages of foodstuff, cosmetics and pharmaceuticals.

In addition, the hybrid material composition obtained by the method of the present invention can be used as an adhesive.

### CITATION LIST

### Patent Literature

US2001/0056197A1
DE3828098A1
JP2011195817 (A)
US2019062495 (A1)
US2011313114 (A1)

As will be understood from the preceding description of the present invention and the illustrative experimental examples, the present invention can also be described by reference to the following embodiments:
1. A method for forming a biodegradable or recyclable hybrid material composition, comprising the steps of
   providing a polymetaloxane-biopolymer composition in liquid state, comprising a biopolymer together with a polymetaloxane prepolymer; and
   subjecting the composition to a curing step in order to form the hybrid material.
2. The method according to embodiment 1, obtained by a method comprising the steps of
   providing biopolymer in a liquid state;
   providing a polymetaloxane prepolymer in a liquid state;
   mixing the biopolymer in liquid state with the polymetaloxane prepolymer in liquid state to provide a biopolymer-polymetaloxane composition; and
      subjecting the composition thus obtained to a curing step in order to form the hybrid material.
3. The method according to embodiment 1 or 2, wherein the polymetaloxane prepolymer in liquid state is gradually added to the liquid phase of the biopolymer to form a polymetaloxane-biopolymer composition.
4. The method according to any of the preceding embodiments, wherein the liquid phase is agitated, in particular vigorously agitated, during the addition or formation of the polymetaloxane prepolymer.
5. The method according to any of the preceding embodiments, comprising forming a polymetaloxane prepolymer in liquid state by hydrolyzation and condensation polymerization of the corresponding monomers.
6. The method according to any of embodiments 1 to 4, comprising providing a ready-made polymetaloxane prepolymer in liquid state.
7. The method according to any of the preceding embodiments, wherein the biopolymer is chemically coupled, in particular crosslinked, with the polymetaloxane prepolymer.
8. The method according to any of the preceding embodiments, wherein the biopolymer is water soluble.
9. The method according to any of the preceding embodiments, wherein the biopolymer exhibits terminal OH groups or double bonds.
10. The method according to any of the preceding embodiments, wherein the biopolymer is a biodegradable polymer material, such as a cellulose ester, like cellulose acetate (CA), a cellulose co-ester, like cellulose acetate butyrate (CAB), cellulose acetate phthalate (CAP), cellulose nitrate (CN), carboxymethyl cellulose (CMC), other ionic water-soluble celluloses, like sodium carbomethyl cellulose, other non-ionic celluloses, microcrystalline cellulose (MCC), microfibrillated cellulose (MFC), nanofibrillated cellulose (NFC), methyl cellulose (MC), hydroxyethyl cellulose (HEC), hydroxypropyl cellulose (HPC), hydroxypropyl methyl cellulose (HPMC); or polyvinylpyrrolidone (PVP); bio-based polybutylene succinate (BioPBS); polyhydroxy alkanoate (PHA); polyhydroxybutyrate (PHB); poly(3-hydroxyburate-co-3-3hydroxyvalerate) (PHBV); polylactic acid or polylactide (PLA); polyglycolic acid or polyglycolide (PGA); starch; chitosan; xylan; lignin or a combination of two or more of the foregoing polymer materials.
11. The method according to any of the preceding embodiments, wherein the biopolymer is fossil-based polymer material, such as poly(butylene adipate) (PBA), polybutylene adipate terephthalate (PBAT), poly(butylene succinate) (PBS), poly(butylene succinate-adipate) (PBSA), poly(butylene sebacate) (PBSE), poly(ethylene adipate) (PEA), poly(ethylene succinate) (PES), poly(ethylene succinate-coadipate) (PESA), poly(ethylene sebacate) (PESE), poly(ortho ester) (POE), polyphosphazenes (PPHOS), poly(propylene succinate) (PPS), poly(tetramethylene adipate) (PTA), poly(tetramethylene succinate) (PTMS), poly(tetramethylene sebacate) (PTSE), poly(trimethylene terephthalate (PTT), polyanhydrides, poly(butylene succinate-co-lactide) (PBSL), poly(butylene succinate-co-terephthalate) (PBST), polybutylene adipate-co-terephthalate (PBAT), polycaprolactone (PCL), polymethylene adipate/terephthalate (PTMAT), poly(vinyl alcohol) (PVOH, PVA, or PVAl), polydioxanone (PDS), polyglycolide or poly(glycolic acid) (PGA) and/or polyethylene glycol (PEG).
12. The method according to any of the preceding embodiments, wherein the biopolymer is selected from the group of polyvinyl alcohol, polylactic acid, polylactide, polyglycolic acid, polyglycolide, polybutylene succinate, polyhydroxy alkanoate, polyhydroxybutyrate, and combinations thereof.
13. The method according to any of the preceding embodiments, wherein the biopolymer is selected from bio-mono-, di- and oligomers and combinations thereof, such as L-lactide.
14. The method according any of the preceding embodiments, wherein the liquid phase comprising the biopolymer is provided as a water solution.
15. The method according to any of embodiments 1 to 13, wherein the liquid phase comprising the biopolymer is provided as a melt.
16. The method according to any of the preceding embodiments, wherein the polymetaloxane-biopolymer composition is subjected to curing by the step of
   increasing the temperature of the composition;
   adding a catalyst to the composition;
   adjusting the pH of the composition; or
   a combination of two or three of said steps.
17. The method according to embodiment 16, wherein the catalyst composition comprises metal alkoxides, such as magnesium isopropoxide, calcium isopropoxide, aluminum isopropoxide, titanium isopropoxide, zirconium isopropoxide, titanium acetylacetonate, titanium butoxide, aluminium lactate, iron lactate and zinc lactate, or non-metal alkoxides, or oxides, such as zinc oxide, titanium oxide and tin oxide, or non-metal octoate complexes, such as zinc octoate, germanium octoate, iron octoate and tin octoate.
18. The method according any of the preceding embodiments, wherein the polymetaloxane prepolymer is selected from the group of siloxane, germanoxane, aluminoxane, titanoxane, zirconoxane, ferroxane and stannoxane prepolymers and formed by hydrolyzing and at least partially condensating the corresponding monomers in the presence of an acid.
19. The method according to any of the embodiments 1-17, wherein the polymetaloxane prepolymer is selected from the group of siloxane, germanoxane and stannoxane prepolymers and formed by hydrolyzing and at least partially condensating the corresponding monomers in alkaline or neutral conditions.
20. The method according to any of the preceding embodiments, comprising forming a colloidal liquid solution by gradually adding the polymetaloxane prepolymer to the liquid phase of the biopolymer.
21. The method according to any of the preceding embodiments, comprising in situ formation of the polymetaloxane prepolymer in the presence of the biopolymer.
22. The method according to embodiment 21, comprising forming a colloidal liquid solution by combining the biopolymer with one or more metaloxane monomers, such as 3-glycidoxypropyl-trimethoxysilane (GPTMS), bis(triethoxysilyl)ethane (BTESE), methyltrimethoxysilane (MTMS), phenyltrimethoxysilane (PTMS) and (3-aminopropyl)triethoxysilane (APTES).
23. The method according to any of the preceding embodiments, wherein the average molecular weight of the prepolymer is about 1000 to 100 000 g/mol, preferably 2000 to 20 000 g/mol.
24. The method according to any of the preceding embodiments, wherein the polymetaloxane prepolymer is used in combination with corresponding dimers having a molecular weight of 500-2000 g/mol or with corresponding raw monomers.
25. The method according to any of the preceding embodiments, wherein the prepolymer is formed in the presence of an acid, in particular an organic acid.
26. The method according to embodiment 25, wherein the biopolymer is coupled to the metaloxane prepolymer at least partially using monomeric organic acids.
27. The method according to embodiment 25 or 26, wherein the organic acid is multifunctional, in particular difunctional.
28. The method according to any of the embodiments 25-27, wherein the organic acid has groups capable of reacting with terminal groups of at least the biopolymer.
29. The method according to any of the embodiments 25-28, wherein the organic acid monomers react with the monomers corresponding to the polymetaloxane prepolymer, and thus become part of the formed polymetaloxane prepolymer.
30. The method according to any of the preceding embodiments, wherein the prepolymer, which preferably comprises a polysiloxane, is formed in the presence of an acid selected from the group of inorganic acids, comprising nitric acid, hydrochloric acid, sulfuric acid, phosphoric acid and boric acid, or from the group of organic acids, comprising lactic acid, acetic acid, formic acid, citric acid, oxalic acid, uric acid, itaconic acid, fumaric acid, succinic acid, gluconic acid, glutamic acid, malic acid, maleic acid, 2,5-furan dicarboxylic acid, 3-Hydroxypropionic acid, glucaric acid, aspartic acid, levulinic acid and combinations thereof.
31. The method according to any of the preceding embodiments, comprising providing a polysiloxane, wherein silane monomers are hydrolyzed and condensated to form a polysiloxane prepolymer, at least 20 mol-%, in particular at least 40 mol-%, for example 50 to 99 mol-% of the silane monomers are hydrolyzed and condensated.
32. The method according to any of the preceding embodiments, wherein a polysiloxane prepolymer is formed at a temperature of 20 to 90° C., wherein the hydrolyzation occurs prior to the condensation which can further be limited by adjusting the temperature and pH of the solution
33. The method according to embodiment 31 to 32, wherein the polymerization degree of the silane monomers is adjusted with temperature and pH.
34. The method according to any of the embodiments 31 to 33, wherein a polysiloxane prepolymer is formed from a mixture of silane monomers, comprising at least two different silane monomers.
35. The method according to any of the embodiments 31 to 34, wherein the siloxane prepolymer is formed by hydrolysing the hydrolysable groups of the silane monomers and then further partially polymerising it by a condensation process.
36. Biodegradable or recyclable hybrid material composition obtained by a method according to any of the preceding embodiments.
37. Use of the composition according to embodiment 36 as a single layer coating on a biobased substrate.
38. A single layer coating composed of the composition according to embodiment 36.
39. The coating according to embodiment 38, characterized in that it is self-standing.
40. The coating according to embodiment 38 or 39, having a thickness of 0.01 to 1000 μm.
41. The coating according to any of embodiments 38 to 40 applied by spraying, brushing or rolling.
42. The composition according to embodiment 36 or the coating according to any of embodiments 38 to 41, which composition or coating is homogeneous.
43. The composition according to embodiment 36 or the coating according to any of embodiments 38 to 41, which composition or coating is transparent, translucent or opaque.
44. Use of the composition according to embodiment 36 or the coating according any of embodiments 38 to 41 as a coating of flexible or rigid substrates.
45. Use of the composition according to embodiment 36 or the coating according any of embodiments 38 to 41 in packages of foodstuff, cosmetics or pharmaceuticals.
46. Use of the composition according to embodiment 36 as an adhesive.

1. A method for forming a biodegradable or recyclable hybrid material composition, comprising the steps of
providing a polymetaloxane-biopolymer composition in liquid state, comprising a biopolymer together with a polymetaloxane prepolymer; and
subjecting the composition to a curing step in order to form the hybrid material.

2. The method according to claim 1, obtained by a method comprising the steps of
providing biopolymer in a liquid state;
providing a polymetaloxane prepolymer in a liquid state;
mixing the biopolymer in liquid state with the polymetaloxane prepolymer in liquid state to provide a biopolymer-polymetaloxane composition; and
subjecting the composition thus obtained to a curing step in order to form the hybrid material.

3. The method according to claim 1, comprising providing a ready-made polymetaloxane prepolymer in liquid state, which ready-made polymetaloxane prepolymer is preferably formed in a liquid state by hydrolyzation and condensation polymerization of the corresponding monomers prior to mixing with the biopolymer.

4. The method according to claim 3, wherein the biopolymer is chemically coupled, in particular crosslinked, with the polymetaloxane prepolymer.

5. The method according to claim 1, wherein the biopolymer is a biodegradable polymer material, such as a cellulose ester, like cellulose acetate (CA), a cellulose co-ester, like cellulose acetate butyrate (CAB), cellulose acetate phthalate (CAP), cellulose nitrate (CN), carboxymethyl cellulose (CMC), other ionic water-soluble celluloses, like sodium carbomethyl cellulose, other non-ionic celluloses, microcrystalline cellulose (MCC), microfibrillated cellulose (MFC), nanofibrillated cellulose (NFC), methyl cellulose (MC), hydroxyethyl cellulose (HEC), hydroxypropyl cellulose (HPC), hydroxypropyl methyl cellulose (HPMC); or polyvinylpyrrolidone (PVP); bio-based polybutylene succinate (BioPBS); polyhydroxy alkanoate (PHA); polyhydroxybutyrate (PHB); poly(3-hydroxyburate-co-3-3hydroxyvalerate) (PHBV); polylactic acid or polylactide (PLA); polyglycolic acid or polyglycolide (PGA); starch; chitosan; xylan; lignin or a combination of two or more of the foregoing polymer materials.

6. The method according to claim 1, wherein the biopolymer is fossil-based polymer material, such as poly(butylene adipate) (PBA), polybutylene adipate terephthalate (PBAT), poly(butylene succinate) (PBS), poly(butylene succinate-adipate) (PBSA), poly(butylene sebacate) (PBSE), poly(ethylene adipate) (PEA), poly(ethylene succinate) (PES), poly(ethylene succinate-coadipate) (PESA), poly(ethylene sebacate) (PESE), poly(ortho ester) (POE), polyphosphazenes (PPHOS), poly(propylene succinate) (PPS), poly(tetramethylene adipate) (PTA), poly(tetramethylene succinate) (PTMS), poly(tetramethylene sebacate) (PTSE), poly(trimethylene terephthalate (PTT), polyanhydrides, poly(butylene succinate-co-lactide) (PBSL), poly(butylene succinate-co-terephthalate) (PBST), polybutylene adipate-co-terephthalate (PBAT), polycaprolactone (PCL), polymethylene adipate/terephthalate (PTMAT), poly(vinyl alcohol) (PVOH, PVA, or PVAl), polydioxanone (PDS), polyglycolide or poly(glycolic acid) (PGA) and/or polyethylene glycol (PEG).

7. The method according to claim 1, wherein the biopolymer is selected from the group of polyvinyl alcohol, polylactic acid, polylactide, polyglycolic acid, polyglycolide, polybutylene succinate, polyhydroxy alkanoate, polyhydroxybutyrate, and combinations thereof.

8. The method according to claim 1, wherein the biopolymer is polyester, preferably selected from the group of polylactic acid, polylactide, polyglycolic acid, polyglycolide, polybutylene succinate, polyhydroxy alkanoate, polyhydroxybutyrate, and combinations thereof.

9. The method according to claim 2, wherein the liquid phase comprising the biopolymer is provided as a water solution.

10. The method according to claim 2, wherein the liquid phase comprising the biopolymer is provided as a melt which is obtained by heating the biopolymer, preferably a polyester, above its melting temperature.

11. The method according to claim 1, wherein the polymetaloxane-biopolymer composition is subjected to curing by the step of
increasing the temperature of the composition;
adding a catalyst to the composition;
adjusting the pH of the composition; or by
a combination of two or three of said steps.

12. The method according claim 1, wherein the polymetaloxane prepolymer is selected from the group of siloxane, germanoxane, aluminoxane, titanoxane, zirconoxane, ferroxane and stannoxane prepolymers and formed by hydrolyzing and at least partially condensating the corresponding monomers.

13. The method according to claim 1, wherein the prepolymer, which preferably comprises a polysiloxane, is formed in the presence of an acid selected from the group of inorganic acids, comprising nitric acid, hydrochloric acid, sulfuric acid, phosphoric acid and boric acid, or from the group of organic acids, comprising lactic acid, acetic acid, formic acid, citric acid, oxalic acid, uric acid, itaconic acid, fumaric acid, succinic acid, gluconic acid, glutamic acid, malic acid, maleic acid, 2,5-furan dicarboxylic acid, 3-Hydroxypropionic acid, glucaric acid, aspartic acid, levulinic acid and combinations thereof.

14. The method according to claim 1, wherein the prepolymer is formed in the presence of an acid, in particular an organic acid, especially a monomeric organic acid.

15. The method according to claim 14, wherein the organic acid is multifunctional, in particular difunctional, preferably levulinic acid, succinic acid, malic acid or combination thereof.

16. The method according to claim 1, comprising providing a polysiloxane, wherein silane monomers are hydrolyzed and condensed to form a polysiloxane prepolymer, at least 20 mol-%, in particular at least 40 mol-%, for example 50 to 99 mol-% of the silane monomers are hydrolyzed and condensated.

17. The method according to claim 16, wherein the polymerization degree of the silane monomers is adjusted with temperature and pH.

18. The method according to claim 16, wherein a polysiloxane prepolymer is formed from a mixture of silane monomers, comprising at least two different silane monomers.

19. The method according to claim 18, wherein the silane monomers have at least one functional group, preferably the silane monomers are selected from the group of 3-glycidoxypropyl-trimethoxysilane (GPTMS), bis(triethoxysilyl)ethane (BTESE), methyltrimethoxysilane (MTMS), phenyltrimethoxysilane (PTMS) and (3-aminopropyl)triethoxysilane (APTES).

20. The method according to claim 1, comprising forming a colloidal liquid solution by gradually adding the polymetaloxane prepolymer to the liquid phase of the biopolymer.

21. The method according to claim 1, comprising in situ formation of the polymetaloxane prepolymer in the presence of the biopolymer.

22. The method according to claim 21, comprising forming a colloidal liquid solution by combining the biopolymer with one or more metaloxane monomers, such as 3-glycidoxypropyl-trimethoxysilane (GPTMS), bis(triethoxysilyl)ethane (BTESE), methyltrimethoxysilane (MTMS), phenyltrimethoxysilane (PTMS) and (3-aminopropyl)triethoxysilane (APTES).

23. The method according to claim 1, wherein the liquid phase is agitated, preferably vigorously agitated, during the addition or formation of the polymetaloxane prepolymer.

24. The method according to claim 1, wherein the average molecular weight, i.e. weight average molar mass, of the prepolymer is about 1000 to 100 000 g/mol, preferably 2000 to 20 000 g/mol.

25. The method according to claim 1, wherein the polymetaloxane prepolymer is used in combination with corresponding dimers having a molecular weight of 500-2000 g/mol or with corresponding raw monomers.

26. The method according to claim 14, wherein the organic acid monomers react with the monomers corresponding to the polymetaloxane prepolymer, and thus become part of the formed polymetaloxane prepolymer.

27. The method according to claim 1, wherein a polysiloxane prepolymer is formed at a temperature of 20 to 90° C., wherein the hydrolyzation of the hydrolysable groups of the silane monomers occurs prior to the condensation which can further be limited by adjusting the temperature and pH of the solution

28. A biodegradable or recyclable hybrid material composition obtained by the method according to claim 1.

29. A single layer coating composed of the composition according to claim 28, having a thickness of 0.01 to 1000 μm, and preferably being self-standing.

30. The coating according to claim 29 applied by spraying, brushing or rolling.

31. The composition according to claim 26, which composition is homogeneous.

32. Use of the composition according to claim 26 as a single layer coating on a biobased substrate; as a coating of flexible or rigid substrates; in packages of foodstuff, cosmetics or pharmaceuticals; or as an adhesive.
